(19) United States
(12) Patent Application Publication
(10) Pub. No.: US 2020/0333493 A1
(43) Pub. Date: Oct. 22, 2020

(54) NON-IMPULSIVE SOURCE ACTUATION

(71) Applicant: PGS Geophysical AS, Oslo (NO)

(72) Inventors: Okwudili Orji, Oslo (NO); Walter F. Söllner, Oslo (NO); David O'Dowd, Oslo (NO)

(73) Assignee: PGS Geophysical AS, Oslo (NO)

(21) Appl. No.: 16/955,181

(22) PCT Filed: Dec. 18, 2018
(86) PCT No.: PCT/EP2018/085690

§ 371 Date: Jun. 18, 2020

Related U.S. Application Data
(60) Provisional application No. 62/607,010, filed on Dec. 18, 2017.

(51) Int. Cl. G01V 1/38

(52) U.S. Cl. CPC G01V 1/3808; G01V 2210/1214

(57) ABSTRACT

Non-impulsive source actuation can include actuating a plurality of non-impulsive sources such that each one of a plurality of common midpoint (CMP) bins receives a desired aggregate signal exposure. Each one of the plurality of non-impulsive sources exposes each one of the plurality of CMP bins to a different part of the desired aggregate signal exposure at different times during the survey.

### CROSS-REFERENCE TO RELATED APPLICATIONS

This application is a National Stage Application under 35 USC § 371 of International Application No. PCT/EP2018/085690, filed Dec. 18, 2018, which claims the benefit of U.S. Provisional Application 62/607,010, filed Dec. 18, 2017, which is hereby incorporated by reference in its entirety.

### BACKGROUND

In the past few decades, the petroleum industry has invested heavily in the development of marine survey techniques that yield knowledge of subterranean formations beneath a body of water in order to find and extract valuable resources, such as oil. High-resolution images of a subterranean formation are helpful for quantitative interpretation and improved reservoir monitoring. For a typical marine survey, a marine survey vessel tows one or more marine survey sources below the sea surface and over a subterranean formation to be surveyed. Marine survey receivers may be located on or near the seafloor, on one or more streamers towed by the marine survey vessel, or on one or more streamers towed by another vessel. The marine survey vessel typically contains marine survey equipment, such as navigation control, source control, receiver control, and recording equipment. The source control may cause the one or more marine survey sources, which can be impulsive sources such as air guns, non-impulsive sources such as marine vibrator sources, electromagnetic sources, etc., to produce signals at selected times. Each signal is essentially a wave called a wavefield that travels down through the water and into the subterranean formation. At each interface between different types of rock, a portion of the wavefield may be refracted, and another portion may be reflected, which may include some scattering, back toward the body of water to propagate toward the sea surface. The marine survey receivers thereby measure a wavefield that was initiated by the actuation of the marine survey source.

### BRIEF DESCRIPTION OF THE DRAWINGS

FIG. 1 is an elevation or xz-plane view of an example marine survey in which signals are emitted by a marine seismic source for recording by marine survey receivers.

FIG. 2 illustrates a plurality of common midpoint (CMP) bins including no full-band bins.

FIG. 3 illustrates an exemplary embodiment of a plurality of CMP bins including a full-band bin.

FIG. 4 illustrates an exemplary embodiment of a method for non-impulsive source actuation

FIG. 5 illustrates an exemplary embodiment of a machine-readable medium for achieving non-impulsive source actuation.

FIG. 6 illustrates an exemplary embodiment of a system for non-impulsive source actuation.

### DETAILED DESCRIPTION

The present disclosure is related to non-impulsive source actuation and survey design for data acquisition using non-impulsive sources. A marine seismic source is a device that generates controlled acoustic energy used to perform marine surveys based on reflection and/or refraction of the acoustic energy. Marine seismic sources can be impulsive sources or non-impulsive sources. Examples of impulsive sources include air guns, water guns, explosive sources (e.g., dynamite), plasma sound sources, boomer sources, etc. An example of a non-impulsive source is a marine vibrator. A marine vibrator can include at least one moving plate. The marine vibrator can be controlled with a time signal that controls motion of the at least one plate of the marine vibrator source. For example, where the signal produced by the motion of the plate can be described as a sweep (where the frequency changes with time), the time signal can be referred to as a sweep signal. A sweep length is the amount of time that it takes for the marine non-impulsive source to operate through its frequency range. An example of a marine vibrator is a bender source, which is a flexural disc projector. A bender source may employ one or more piezoelectric elements, such that the mechanical vibration of the bender source is driven by piezoelectric distortion based on electrical energy applied to the piezoelectric element.

Impulsive sources as conventionally used may not be able to generate enough acoustic energy at low frequencies. As used herein, a “low frequency” includes frequencies from approximately 1 Hertz (Hz) to approximately 8 Hz, or in some cases (as, for example, impulsive source technology improves) frequencies from approximately 1 Hz to approximately 4 Hz. A non-impulsive source can generate acoustic energy over a range of frequencies, including low frequencies. A sweep signal for a non-impulsive source can be used to generate energy at low frequencies from the non-impulsive source with a desired signal to noise ratio where marine impulsive sources may fail to generate sufficient energy. The non-impulsive source may be swept over a range of frequencies. This technique may result in energy spread out with the sweep and less environmental impact than using a marine impulsive source such as air guns. For instance, a sound pressure level (SPL) from a non-impulsive source is lower as compared to an impulsive source of the same sound exposure level (SEL) because the energy from a non-impulsive source is spread out over time.

Controlled signals associated with non-impulsive sources can include sweeps where frequencies change with time such as linear sweeps, logarithmic sweeps, coded sweeps, or exponential sweeps, among others. At least one embodiment includes linear sweeps, and examples herein may be described with respect to a linear sweep. However, examples are not so limited, and at least one embodiment of the present disclosure can be performed using other controlled signals or other sweeps. For instance, at least one embodiment of the present disclosure includes the use of pseudo-random sequences or other controlled signal or sweep approaches.

A linear sweep includes a sweep where frequency is a linear function of time, and non-linear sweep includes a sweep where frequency is not a linear function of time. For instance, a non-linear sweep may include a logarithmic sweep wherein frequency varies logarithmically with time. Other non-linear sweeps include sequences produced by random number generators, such as pseudorandom sequences, for instance. These and other types of sweep signals may also be utilized.

Some data acquisition approaches using sweeps include using long signals such as linear sweeps that result in signal drift, which can include frequency drift in common midpoint (CMP) bins. Signal drift, as used herein, occurs when a CMP bin does include all of the desired signals (e.g. all of the desired frequencies). A CMP bin, as used herein, relates to a midpoint location between a source position and a receiver position. The CMP bin may be a subdivision of the subsurface area or volume that is the target of marine survey. For instance, the marine survey may be divided into a grid with the CMP bin being a grid cell. Traces may be assigned to the bins, for example, based on the common midpoint of the trace (e.g., midpoint between a source and a receiver for that trace). The use of long signal lengths such as long sweep lengths, whether linear or non-linear, for the time signal driving the non-impulsive source can be an impediment. The long signal lengths for a given frequency range are used to reach a desired energy output or signal-to-noise (S/N) ratio at the subsurface location that is the target of the marine survey. The signal length plus reflection time defines the total time for each CMP bin in a towed streamer acquisition. The CMP bin size is related to the signal bandwidth and is given by half of the minimal wavelength. For a desired marine survey vessel speed and predefined sweep length, this may create signal drift in the CMP bins for vessel speeds that are too fast, or oversampling for vessel speeds that are too slow. For instance, frequency drift may occur when a CMP bin has not been exposed to every desired frequency band. This can lead to inefficient data acquisition.

For instance, in order to image a subsurface location, a particular S/N ratio is required, which can vary based on the geology of the subsurface location. A combination of the desired energy output and quantity of sources can be adjusted to give the desired S/N ratio. The energy output from a given marine non-impulsive source can be increased by using longer sweeps. Longer sweeps, however, can lead to CMP bin signal drift. A long signal length, as used herein, includes a signal length above a threshold time limit. In at least one embodiment, a signal length such as a sweep length is considered too long if, for a given CMP bin size and marine survey vessel speed, any of the swept frequencies do not fall into that CMP bin, or the towed equipment has passed the CMP bin before all the frequencies are swept. This implies the occurrence of signal drift for that CMP bin. In at least one embodiment, a signal length is considered long if it takes longer than one second. While one second is used as an example threshold time limit, embodiments are not so limited.

Other data acquisition approaches include the use of short signal lengths including short sweep lengths, for instance, to overcome signal drift. This, however, may result in poor S/N ratios in the CMP bins. A short signal length, as used herein, includes a signal length below a threshold time limit. A signal length is considered too short if, for a CMP bin covered during a sweep, the S/N ratio required to image the CMP bin is not fulfilled. For instance, a signal length is considered short if it takes less than one second. While one second is used as an example threshold time limit, embodiments are not so limited. Signal drift, as used herein, refers to a situation in which each CMP bin does not include a full band of signals, such as frequencies in the case of frequency drift, swept from a non-impulsive source (i.e., not having all the frequencies in each CMP bin). With respect to pseudorandom signals, signal drive occurs when only part of a signal falls into a CMP bin, which can lead to lower CMP bin contribution before correction of the signal drift. The signal drift can increase with increasing linear sweep length because an associated marine survey vessel is in constant motion as the signal is delivered.

The signal sampling Nyquist criterion suggests that a continuous time signal can be represented in its samples and can be recovered back when sampling frequency fₛ is greater than or equal to twice the highest frequency component of a message signal. For instance:

fₛ≥2fₘ.

This suggests that a smallest CMP bin size dictated by a highest swept frequency should be used for imaging. When long linear sweeps are used by marine survey vessels moving at marine survey vessel speeds such as 2.5 meters per second (m/s), the signal sampling Nyquist criterion may be violated for higher frequencies. In order to correct this, a marine survey vessel can move at a slower speed or use shorter sweep lengths. This, however, can result in poor S/N ratios in the CMP bins, inefficient seismic surveys, or safety issues. For instance, a marine survey vessel has a threshold speed at which it must move in order to maintain tension on a towed streamer spread to keep the spread from collapsing.

Examples of the present disclosure can use randomized simultaneous linear sweeps with non-impulsive sources to acquire seismic data and improve imaging of a subsurface location. The randomization times, in at least one embodiment, are determined such that missing frequencies are filled “on the fly” by neighboring sources. For instance, as a marine survey vessel moves, randomized simultaneous non-impulsive sources having a threshold distance or time delay between them are used, and more accurate sampling can be achieved by filling missing frequencies from neighboring sources into each CMP bin. In at least one embodiment, the randomization aids non-impulsive source separation. For instance, deblending noise is reduced as compared to other approaches. In such an example, the marine survey vessel moves with normal or increased data acquisition speed while collecting accurate information with desired S/N ratios and reduced or no signal drift, such as frequency drift. For instance, examples of the present disclosure allow for shorter sweeps for a plurality of sources to build a desired or required S/N ratio.

With optimized actuation of non-impulsive sources and sweep lengths, signal drift for CMP bins can be reduced or eliminated and faster vessel speeds can be used, which can reduce the effective data acquisition duration. Such improvements to the technological process of marine seismic surveying can also reduce the cost of data acquisition by reducing the amount of fuel used as well as the time used for data acquisition. Such improvements can also reduce the environmental impact of the marine seismic survey.

As used herein, the singular forms “a”, “an”, and “the” include singular and plural referents unless the content clearly dictates otherwise. Furthermore, the word “may” is used throughout this application in a permissive sense (i.e., having the potential to, being able to), not in a mandatory sense (i.e., must). The term “include,” and derivations thereof, mean “including, but not limited to.” The term “coupled” means directly or indirectly connected.

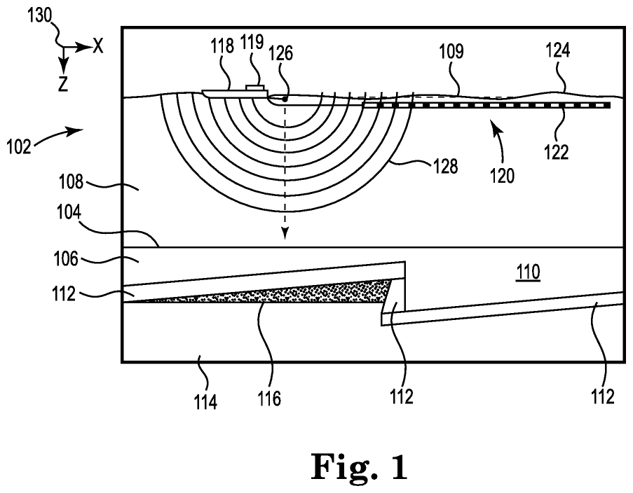

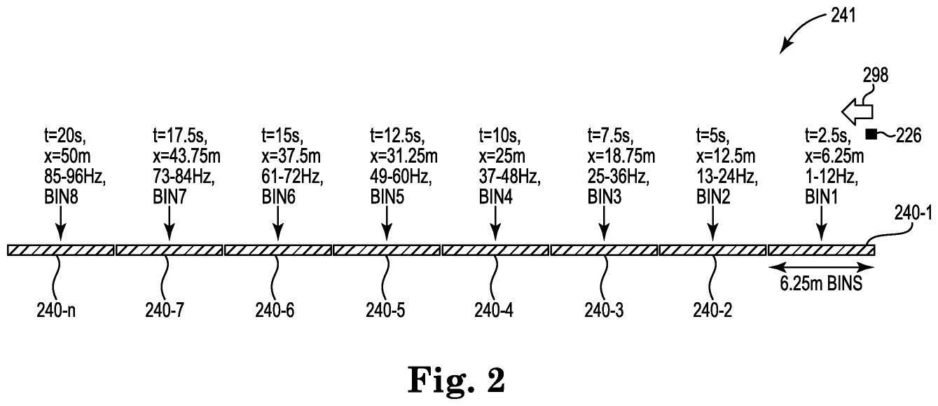

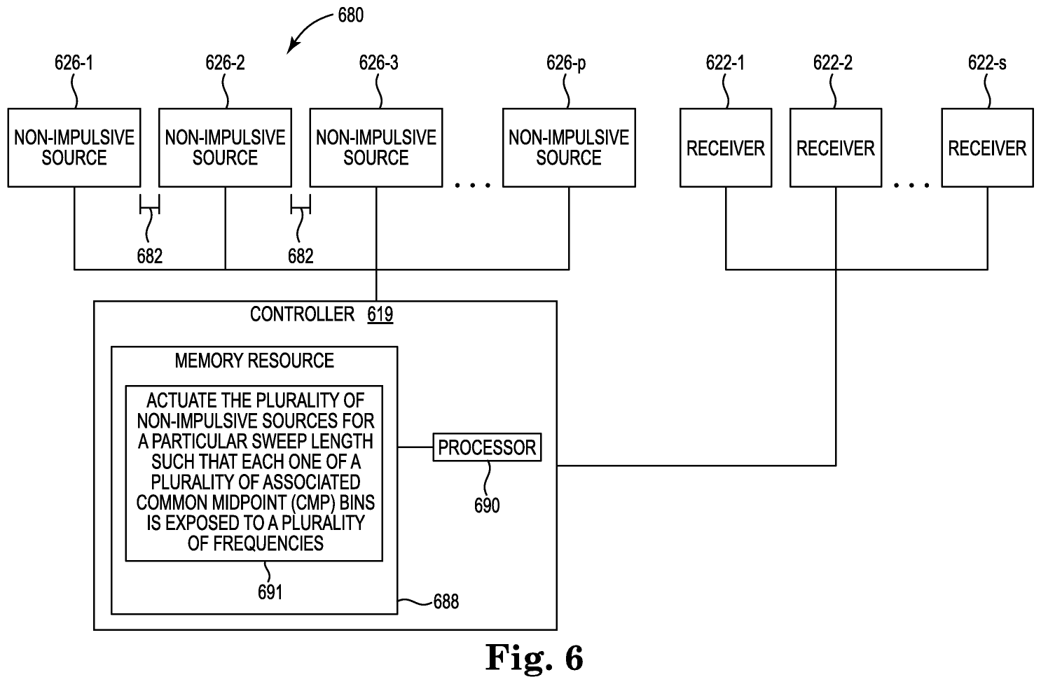

The figures herein follow a numbering convention in which the first digit or digits correspond to the drawing figure number and the remaining digits identify an element or component in the drawing. Similar elements or components between different figures may be identified by the use of similar digits. For example, 119 may reference element “19” in FIG. 1, and a similar element may be referenced as 619 in FIG. 6. Analogous elements within a FIG. may be referenced with a hyphen and extra numeral or letter. See, for example, elements 240-1, and 240-2 in FIG. 2. Such analogous elements may be generally referenced without the hyphen and extra numeral or letter. For example, elements 240-1 and 240-2 may be collectively referenced as 240. As will be appreciated, elements shown in the various embodiments herein can be added, exchanged, and/or eliminated so as to provide a number of additional embodiments of the present disclosure. In addition, as will be appreciated, the proportion and the relative scale of the elements provided in the figures are intended to illustrate certain embodiments of the present invention and should not be taken in a limiting sense.

FIG. 1 illustrates an elevation or xz-plane 130 view of a marine survey in which signals are emitted by a marine survey source 126 for recording by marine survey receivers 122. The recording can be used for processing and analysis in order to help characterize the structures and distributions of features and materials underlying the surface of the earth. For example, the recording can be used to estimate a physical property of a subsurface location, such as the presence of a reservoir that may contain hydrocarbons. FIG. 1 shows a domain volume 102 of the earth's surface comprising a subsurface volume 106 of sediment and rock below the surface 104 of the earth that, in turn, underlies a fluid volume 108 of water having a sea surface 109 such as in an ocean, an inlet or bay, or a large freshwater lake. The domain volume 102 shown in FIG. 1 represents an example experimental domain for a class of marine surveys. FIG. 1 illustrates a first sediment layer 110, an uplifted rock layer 112, underlying rock layer 114, and hydrocarbon-saturated layer 116. One or more elements of the subsurface volume 106, such as the first sediment layer 110 and the uplifted rock layer 112, can be an overburden for the hydrocarbon-saturated layer 116. In some instances, the overburden may include salt.

FIG. 1 shows an example of a marine survey vessel 118 equipped to carry out marine surveys. In particular, the marine survey vessel 118 can tow one or more streamers 120 (shown as one streamer for ease of illustration) generally located below the sea surface 109. The streamers 120 can be long cables containing power and data-transmission lines (e.g., electrical, optical fiber, etc.) to which marine survey receivers may be coupled. In one type of marine survey, each marine survey receiver, such as the marine survey receiver 122 represented by the shaded disk in FIG. 1, comprises a pair of sensors including a geophone that detects particle displacement within the water by detecting particle motion variation, such as velocities or accelerations, and/or a hydrophone that detects variations in pressure. In one type of marine survey, each marine survey receiver, such as marine survey receiver 122, comprises an electromagnetic receiver that detects electromagnetic energy within the water. The streamers 120 and the marine survey vessel 118 can include sensing electronics and data-processing facilities that allow marine survey receiver readings to be correlated with absolute positions on the sea surface and absolute three-dimensional positions with respect to a three-dimensional coordinate system. In FIG. 1, the marine survey receivers along the streamers are shown to lie below the sea surface 109, with the marine survey receiver positions correlated with overlying surface positions, such as a surface position 124 correlated with the position of marine survey receiver 122. The marine survey vessel 118 can include a controller 119, which is described in more detail with respect to FIG. 6. For example, the controller 119 can be used for non-impulsive source actuation for data acquisition as described herein.

The marine survey vessel 118 can tow one or more marine survey sources 126 that produce signals as the marine survey vessel 118 and streamers 120 move across the sea surface 109. Although not specifically illustrated, the marine survey sources 126 can include a plurality of marine non-impulsive sources above, below, or at a same depth as the streamer 120. Marine survey sources 126 and/or streamers 120 may also be towed by other vessels or may be otherwise disposed in fluid volume 108. For example, marine survey receivers may be located on ocean bottom cables or nodes fixed at or near the surface 104, and marine survey sources 126 may also be disposed in a nearly-fixed or fixed configuration. For the sake of efficiency, illustrations and descriptions herein show marine survey receivers located on streamers, but it should be understood that references to marine survey receivers located on a “streamer” or “cable” should be read to refer equally to marine survey receivers located on a towed streamer, an ocean bottom receiver cable, and/or an array of nodes.

FIG. 1 shows acoustic energy as an expanding, spherical signal, illustrated as semicircles of increasing radius centered at the marine survey source 126, representing a down-going wavefield 128, following a signal emitted by the marine survey source 126. The down-going wavefield 128 is, in effect, shown in a vertical plane cross section in FIG. 1. The outward and downward expanding down-going wavefield 128 may eventually reach the surface 104, at which point the outward and downward expanding down-going wavefield 128 may partially scatter, may partially reflect back toward the streamers 120, and may partially refract into the subsurface volume 106, becoming elastic signals within the subsurface volume 106.

FIG. 2 illustrates a diagram 241 of a plurality of CMP bins 240 including no full-band bins. In the example illustrated in FIG. 2, each CMP bin has a size of 6.25 m measured in the inline direction 298. A marine survey vessel towing a non-impulsive source 226 is moving through a body of water in direction 298, and the non-impulsive source 226 is actuated. In such an example, because all frequencies are not released by the non-impulsive source 226 at one time, each of the plurality of CMP bins 240 is exposed to different frequencies, and none of the plurality of CMP bins 240 is exposed to all available frequencies or a desired number of frequencies. Because each of the plurality of CMP bins 240 is exposed to different frequencies, accurate imaging of an associated subsurface or subterranean formation may not be possible. In order to accurately image a point on the subsurface, approximately all frequencies emitted from a source need to reflect from that point in order to accurately average common depth points (CDPs), which are used for imaging seismic data.

For instance, as illustrated in FIG. 2, if the marine survey vessel towing the non-impulsive source 226 is moving at 2.5 m/s in direction 298, and each one of the plurality of CMP bins is 6.25 meters (m) in size, the first bin 240-1 is exposed to only lower frequencies such as 1-12 Hz if the sweep starts at low frequencies and emits higher frequencies as it progresses. In the example, the total length of the sweep is 20 s, and the intended frequency band, which here is full-band coverage, for each CMP bin is 1-96 Hz, which is also the frequency content of each non-impulsive source. As the non-impulsive source 226 moves at 2.5 m/s, at 5 seconds having traveled 12.5 m, the second CMP bin 240-2 is only exposed to particular frequencies, for instance 13-24 Hz. As the non-impulsive source 226 continues to move, each CMP bin 240 is exposed to different frequencies, but none is exposed to all available or desired frequencies. Put another way, different CMP bins are exposed to different frequency bands, which may result in seismic data recorded at receivers that cannot be accurately imaged. In the example illustrated in FIG. 2, “t” represents time and “x” represents distance traveled.

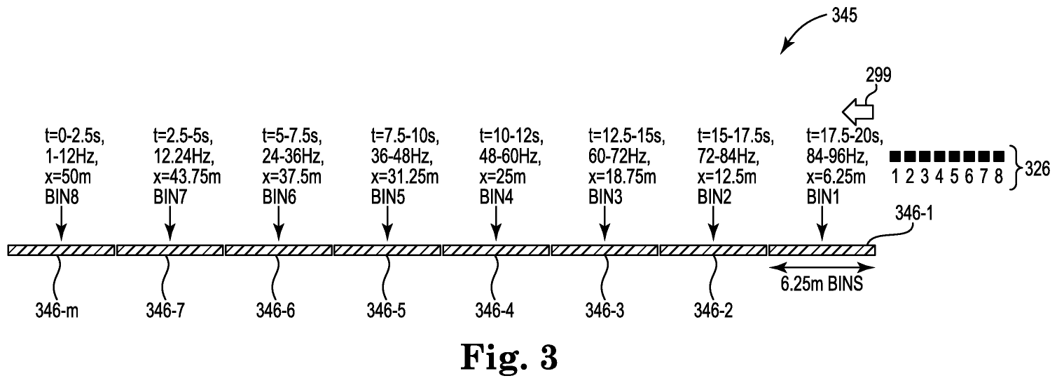

FIG. 3 illustrates a diagram 345 of an exemplary embodiment of a plurality of CMP bins 346 including a full-band CMP bin 346-1. In the example illustrated in FIG. 3, a marine survey vessel towing a plurality of non-impulsive sources 326 is moving through a body of water in direction 399, and the plural non-impulsive sources 326 are actuated. The particular distance may be a CMP bin size. For example, each one of the plurality of CMP bins may be approximately 6.25 m in length, meaning the particular distance separating the sources is approximately 6.25 m. In at least one embodiment, randomization results in the particular distance being a CMP bin size plus an additional distance corresponding to the range of the randomization. This can be referred to as an actuation randomization length and can have an upper threshold. Values above the upper threshold may not result in accurate results or may cause inefficiencies in seismic data acquisition. While eight non-impulsive sources and eight CMP bins are illustrated in FIG. 3, examples are not so limited. More or fewer non-impulsive sources and more or fewer CMP bins may be present.

As the marine survey vessel moves, each one of the plurality of non-impulsive sources 326 is actuated such that each one of the plurality of non-impulsive sources 326 exposes different ones of the plurality of CMP bins 346 to different frequencies, or put another way, different frequency contributions. For example, each one of the plurality of non-impulsive source 326 has the same frequency band, for instance from 1-96 Hz. The plurality of non-impulsive sources 326 is spaced by approximately the CMP bin 346 size. As the marine survey vessel moves in direction 399, a given CMP bin 346 gets different frequency contributions from successive non-impulsive sources of the plurality of non-impulsive sources 326. For instance, the first CMP bin 346-1 is exposed to 1-12 Hz during the first 2.5 s (e.g., covering 0-2.5 s) and is exposed to 12-24 Hz from the second source during the second 2.5 s (e.g., covering 2.5 s to 5 s.) As time passes, CMP bin 346-1 is exposed to each frequency, while the other CMP bins receive other portions of the total frequency. For instance, in the first 2.5 s, CMP bin is exposed to the lowest frequency of 1-12 Hz, and in the last 2.5 s, CMP bin 346-1 is exposed to the highest frequency of 84-96 Hz. In between those times, CMP bin 346-1 is exposed to the intermediate frequencies.

For example, if each of the plurality of non-impulsive sources 326 is actuated with the same sweep signal from 1-96 Hz, and the plurality of non-impulsive sources 326 are spaced apart by the CMP bin size, then cycles of CMP bins 346 may be achieved that will be “filled” by the plurality of non-impulsive sources 326 passing over them. In at least one embodiment, the sweep may be timed so that it takes just as long to sweep from 1-96 Hz as it does to traverse the plurality of CMP bins 346 in the cycle. For instance, for a set of 8 non-impulsive sources, each of them may sweep from 1-96 Hz over a length of time corresponding to the time it takes to traverse 8 CMP bins. The cycle may then repeat.

CMP bin 346-1, once exposed to each frequency, is a full-band CMP bin because it has been exposed to the threshold number of frequency bands desired to obtain accurate seismic imaging. For instance, CMP bin 346-1 is exposed to 8 frequency bands (1-12 Hz, 12-24 Hz, . . . , 84-96 Hz), resulting in a full-band CMP bin. Diagram 345 illustrates that the plurality of CMP bins 346 can be filled in “on the fly” or dynamically. For instance, when all of the plurality of non-impulsive sources 326 are turned on, as the marine survey vessel passes the plurality of CMP bins 346 in real time, each CMP bin 346 is sequentially exposed or “filled” with a frequency band that is a subset of the full range of frequencies desired for a full band CMP bin. CMP bin 346-1 is exposed to a full range of frequency bands, resulting in a full-band CMP bin.

In at least one embodiment using a plurality of non-impulsive sources 326 operating over a same frequency range, each of the plurality of non-impulsive sources 326 can be operated with randomized start times relative to each other. For instance, the actuation of different non-impulsive sources can be randomized versus each other, which allows for easier source separation during data processing including deblending.

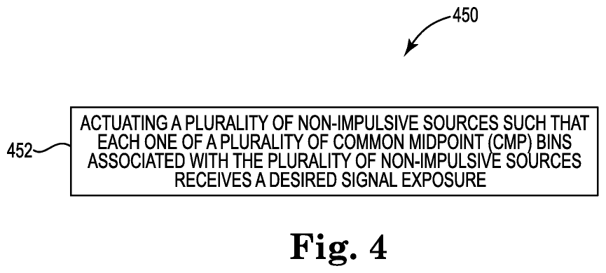

FIG. 4 is an exemplary embodiment of a method flow diagram 450 for non-impulsive source actuation. At 452, the method of performing a marine seismic survey includes actuating a plurality of non-impulsive sources such that each one of a plurality of CMP bins receives a desired aggregate signal exposure. Each one of the plurality of non-impulsive sources exposes each one of the plurality of CMP bins to a different part of the desired aggregate signal exposure at different times during the survey. The desired aggregate signal exposure, as used herein, comprises a frequency band, and the different parts comprise subsets of the frequency band. For instance, an undesirable aggregate signal exposure may include a CMP bin being exposed to only 6 of 8 desired frequency band ranges. In at least one embodiment, the plurality of CMP bins is exposed to a plurality of signals responsive to the actuation until each of the plurality of CMP bins is a full-band bin. The plurality of non-impulsive sources may be spaced apart in an in-line direction or arrangement in at least one embodiment such that each one of the plurality of sources contributes different parts of the frequency band as it passes over each one of the plurality of CMP bins. For instance, a first CMP bin may be exposed to a first part of the frequency band by a first non-impulsive source and a second part of the frequency band by a second non-impulsive source. Each CMP bin can be exposed to each one of a plurality of different frequency bands associated with the plurality of non-impulsive sources subsequent to completion of a sweep. In such an example, each one of the plurality of CMP bins can be a full-band bin. In at least one embodiment, each of the plurality of CMP bins has an in-line dimension. In such an example, spacing the plurality of sources apart comprises spacing each one of the plural sources from its nearest neighbor by a distance that corresponds to the in-line dimension of one of the CMP bins.

In at least one embodiment, the plurality of non-impulsive sources is actuated within an upper threshold of delay time. For instance, each one of the plural non-impulsive sources is actuated within approximately one second of one another, or other upper threshold of delay time. In some instances, the actuation can result in the actuation occurring within an upper threshold of delay time plus an upper threshold of actuation randomization length. For example, additional time may be added to randomize the actuations. This can improve non-impulsive source separation subsequent to seismic data collection.

Blending of seismic data associated with the non-impulsive source actuation method of diagram 450 can be performed in a plurality of ways. For instance, blending can include randomizing the source separation distances, as noted above, or having uniform source separation but randomizing the starting time of each source or combining the first two non-impulsive sources. Combing the first two non-impulsive sources can include overlapping the actuations of the first two non-impulsive sources. In at least one embodiment including linear sweeps, blending includes randomizing the initial phases of the sweeps for uniform start time and spacing or combining the first three sources. Other blending approaches may be used in other embodiments.

Each one of the plurality of non-impulsive sources addresses each one of the plurality of CMP bins in at least one embodiment. In some instances, the plurality of non-impulsive sources number the same as the plurality of CMP bins addressed in a cycle by each one of the moving non-impulsive sources. For instance, if there are eight CMP bins in a cycle, eight non-impulsive sources are employed. Other numbers of CMP bins and non-impulsive sources may be used with different cycle lengths. In at least one embodiment, the number of sources available, actuated, or both, is dictated by a required S/N ratio and restrictions on a trace length.

The coverage, in at least one embodiment, is determined by determining to which signal bands, such as frequency bands, each one of the plurality of CMP bins was exposed. For instance, a coverage is the number of signal bands to which a CMP bin has been exposed. For example, in an example using sweeps and frequency bands, a CMP bin exposed to one frequency band is a one-coverage CMP bin, whereas a bin exposed to five frequency bands is a five-coverage CMP bin. In some instances, a full-band CMP bin may be referred to as a full-coverage bin because the CMP bin has been exposed to all of the available or desired frequency bands. In at least one embodiment, determining the coverage includes determining when each one of the CMP bins was exposed to each one of the plurality of signals and determining whether each one of the CMP bins is a full-band CMP bin.

In at least one embodiment, the plurality of CMP bins is exposed to the plurality of signals responsive to the actuation of the plurality of non-impulsive sources until the plurality of CMP bins are covered by a full-frequency band of the plurality of non-impulsive sources. For instance, once all of the available or desired signal bands have passed over and exposed frequencies to the CMP bins, the exposure is complete. In another embodiment, exposure of the plurality of signals includes exposing the plurality of CMP bins to the plurality of signals responsive to the actuation of the plurality of non-impulsive sources until one of the plurality of CMP bins is a full-band CMP bin. For instance, when a bin has been exposed to all available and/or desired signal bands, exposure is complete for that bin. Put another way, when the coverage of a CMP bin is determined to be equal to all available and/or desired signal bands, exposure is complete for that bin.

Seismic data can be recorded at a plurality of receivers configured to record seismic data associated with the actuating. The recording can be used for processing and analysis in order to help characterize the structures and distributions of features and materials underlying the surface of the earth. For example, the recording can be used to estimate a physical property of a subsurface location, such as the presence of a reservoir that may contain hydrocarbons.

In at least one embodiment, the method described with respect to FIG. 4 includes a process for randomized non-impulsive source arrangement, wherein the method is a specific improvement consisting of element 452. In at least one embodiment, the specific improvement includes an improved arrangement of non-impulsive sources and improved imaging resulting from seismic data collected using the improved arrangement. In at least one embodiment, the specific improvement is an improvement to the technological process of marine seismic surveying that reduces the cost of data acquisition by reducing the amount of fuel used as well as the time used for data acquisition, as well as reducing the environmental impact of the marine seismic survey.

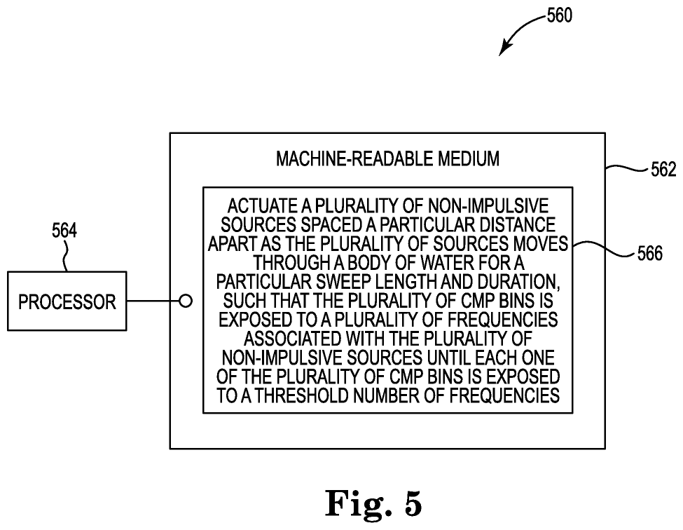

FIG. 5 illustrates a diagram 560 of an exemplary embodiment of a machine-readable medium 562 for non-impulsive source actuation. The machine-readable medium 562 can be non-transitory. The machine-readable medium 562 can, in at least one embodiment, be analogous to the memory resource 688 illustrated in FIG. 6. The machine-readable medium 562 can store instructions executable by a processor 564. For example, at 566, the machine-readable medium 562 can store instructions executable to actuate a plurality of non-impulsive sources spaced a particular distance apart as the plurality of sources moves through a body of water for a particular sweep length and duration, such that each one of the plurality of CMP bins is exposed to a plurality of different frequencies associated with the plurality of non-impulsive sources at different times during a survey until each one of the plurality of CMP bins is exposed to a threshold number of frequencies. In at least one embodiment, the particular distance is at most equal to an in-line dimension of each one of the plurality of CMP bins addressed by each one of the plurality of non-impulsive sources. For instance, the distance between CMP bins is the same size as one CMP bin. The actuation occurs in a plurality of simultaneous long linear sweeps, in a plurality of simultaneous short linear sweeps, or in a plurality of non-linear sweeps, among others.

In at least one embodiment, the exposure of each one of the plurality of CMP bins to the threshold number of frequencies results in each one of the plurality of CMP bins being a full-frequency and CMP bin. For instance, in at least one embodiment, the number of non-impulsive sources in the plurality of non-impulsive sources is the same as the number of CMP bins in a cycle addressed by each one of the plurality of non-impulsive sources. In such an example, in order for the plurality of CMP bins to be exposed to a threshold number of frequencies, each one of the plurality of CMP bins in the cycle is addressed by each one of the plurality of non-impulsive sources. If there are eight non-impulsive sources and eight CMP bins, each one of the eight non-impulsive sources addresses each one of the eight CMP bins. Each CMP bin may be exposed to different frequencies from different non-impulsive sources, such that they become full-band CMP bins “on the fly” after complete exposure to the threshold number of frequencies. For instance, as the marine survey vessel and non-impulsive sources pass over the CMP bins, the CMP bins are exposed to the different frequencies.

With respect to the complete exposure, once all of the available or desired frequency bands have passed over and exposed frequencies to the CMP bins, the exposure is complete. In another embodiment, exposure of the plurality of frequencies includes exposing the plurality of CMP bins to the plurality of frequencies responsive to the actuation of the plurality of non-impulsive sources until one of the plurality of CMP bins is a full-band CMP bin. For instance, when a bin has been exposed to all available and/or desired frequency bands, exposure is complete. Put another way, when the coverage of a CMP bin is determined to be equal to all available and/or desired frequency bands, exposure is complete.

In at least one embodiment, the plurality of non-impulsive sources 626 is arranged in-line, and each one of the plurality of CMP bins is exposed to different parts of the plurality of frequencies sequentially responsive to the actuation of the plurality of non-impulsive sources 626. For instance, non-impulsive sources 626 can expose CMP bins in a particular order. A first non-impulsive source fills a first CMP bin and continues to subsequent CMP bins in the particular order.

In at least one embodiment, the machine-readable medium 562 can store instructions executable to generate an image of a subterranean formation using seismic data recorded at a plurality of receivers and associated with the full-coverage CMP bin. The image, the displayed subterranean formation, or a combination thereof can be useful to prospectors seeking to extract hydrocarbons that may be associated with the subsurface location.

FIG. 6 illustrates a diagram of an exemplary embodiment of a system 680 for non-impulsive source actuation. The marine seismic survey system 680 can include a controller 619 that, in at least one embodiment, can be analogous to or implemented by the controller 119 illustrated in FIG. 1. In at least one embodiment, the controller 619 can represent functionality that is partially implemented by the controller 119 illustrated in FIG. 1 and partially implemented by a different controller, such as a different controller onboard the marine survey vessel or on shore. For example, the controller 619 being analogous to the controller 119 illustrated in FIG. 1 and can be configured to operate the non-impulsive sources 626 and receive data from the receivers 622, while a different controller can be configured to perform other functions described herein. For ease of explanation, the controller 619 will be referred to herein as a single physical controller, however embodiments are not so limited. The non-impulsive sources 626 are analogous to the non-impulsive source 126 illustrated in FIG. 1. The receivers 612 are analogous to the receivers 122 illustrated in FIG. 1.

The system 680 includes the plurality of receivers 622 configured to record seismic data and the plurality of non-impulsive sources 626. In at least one embodiment, the non-impulsive sources 626 are spaced a particular distance 682, which may be at most the length of one of a plurality of CMP bins plus an upper threshold of actuation randomization length. The controller 619 includes hardware, such as processor 690 and is coupled to the plurality of non-impulsive sources 626 and the plurality of receivers 622.

The system 680 can utilize software, hardware, firmware, and/or logic to perform a number of functions. The system can be a combination of hardware and executable instructions configured to perform a number of functions (e.g., actions). The hardware, for example, can include a processor 690, such as at least one processor, and a memory resource 688, such as a machine-readable medium or other non-transitory memory resource 688. The memory resource 688 can be internal and/or external to the system. For example, the system 680 can include an internal memory resource and have access to an external memory resource. Executable instructions can be stored on the machine-readable medium as machine-readable and executable and to implement a particular function. For example, the executable instructions can be executed by the processor 690. The memory resource 688 can be coupled to the system 680 in a wired and/or wireless manner. For example, the memory resource 688 can be an internal memory, a portable memory, a portable disk, and/or a memory associated with another resource, for example, enabling the executable instructions to be transferred and/or executed across a network such as the Internet. In at least one embodiment, the memory resource 688 can be a plurality of non-transitory machine-readable media.

Although illustrated as including instructions, such as software, firmware, etc., executable by the processor 690, the controller 619, in at least one embodiment, can include hardware, such as hard-wired program logic, or a combination of hardware and program instructions configured to perform the functions described herein. Hardware is a physical component of a machine that enables it to perform a function. Examples of such hardware can include a field programmable gate array, an application specific integrated circuit, etc.

The memory resource 688 can be non-transitory and can include volatile and/or non-volatile memory. Volatile memory can include memory that depends upon power to store information, such as various types of dynamic random-access memory among others. Non-volatile memory can include memory that does not depend upon power to store information. Examples of non-volatile memory can include solid-state media such as flash memory, electrically erasable programmable read-only memory, phase change random access memory, magnetic memory, optical memory, and/or a solid-state drive, etc., as well as other types of non-transitory machine-readable media.

The processor 690 can be coupled to the memory resource 688 via a communication path. The communication path can be local or remote to system. Examples of a local communication path can include an electronic bus internal to a machine, where the memory resource 688 is in communication with the processor 690 via the electronic bus. Examples of such electronic buses can include Industry Standard Architecture, Peripheral Component Interconnect, Advanced Technology Attachment, Small Computer System Interface, Universal Serial Bus, among other types of electronic buses and variants thereof. The communication path can be such that the memory resource 688 is remote from the processor 690, such as in a network connection between the memory resource 688 and the processor 690. That is, the communication path can be a network connection. Examples of such a network connection can include a local area network, wide area network, personal area network, and the Internet, among others.

The processor 690 can execute and the memory resource 688 can store instructions at 691 to actuate the plurality of non-impulsive sources for a such that each one of a plurality of associated common midpoint (CMP) bins is exposed to a plurality of frequencies during a survey. For instance, controller 619 is configured to actuate each of the plural non-impulsive sources 626 according to a sweep signal. The sweep signal can produce a linear sweep or a non-linear sweep. In at least one embodiment, the actuation occurs over a particular sweep length. The particular sweep length is a particular linear sweep length, a particular exponential sweep length, or a particular length of another sweep type. In at least one embodiment, the particular sweep length takes a predetermined amount of time. The time can be shorter than other approaches that do not use the randomized non-impulsive source arrangement described herein. In at least one embodiment, each one of the pluralities of non-impulsive sources addresses each one of the plural CMP bins with different frequencies. For example, the processor 690 can execute and the memory resource 688 can store instructions to expose the plurality of CMP bins to a plurality of frequencies associated with the plurality of non-impulsive sources 626. Each one of the plurality of non-impulsive sources 626 can expose each one of the plurality of CMP bins to a different subset of the plurality of frequencies at different times during the survey, for instance. In at least one embodiment, the plurality of CMP bins is exposed dynamically as the plurality of non-impulsive sources is actuated. Each one of the plurality of non-impulsive sources exposes each one of the plurality of CMP bins to different frequency bands. Responsive to the exposure, the CMP bins are full-band CMP bins. For instance, as the plurality of non-impulsive sources expose the plurality of CMP bins to different frequencies, eventually the CMP bins are collectively exposed by different non-impulsive sources to all of the available or desired frequency bands, resulting in full-band CMP bins.

In at least one embodiment, the plural non-impulsive sources 626 are space apart in an in-line direction. Each one of the plurality of CMP bins has an in-line direction, in at least one embodiment. In such an example, each one of the plurality of non-impulsive sources is spaced apart form its nearest neighbor by a distance corresponding to the in-line dimension of one of the CMP bins.

In at least one embodiment, the processor 690 can execute and the memory resource 688 can store instructions to collect trace information associated with the plurality of CMP bins subsequent to the exposure. For instance, the trace information can include information about the subsurface based on the data recorded at receivers associated with the plurality of CMP bins. This information can be useful for determining the presence of a reservoir that may contain hydrocarbons.

In accordance with at least one embodiment of the present disclosure, a geophysical data product may be produced or manufactured. Geophysical data may be obtained by actuating a plurality of non-impulsive sources in a body of water such that each one of a plurality of CMP bins receives a desired aggregate signal exposure. Each one of the plurality of non-impulsive sources exposes each one of the plurality of CMP bins to a different part of the desired aggregate signal exposure at different times during the survey. The geophysical data, such as reflected seismic signals, is recorded in a tangible machine-readable medium such as medium 692, thereby completing the manufacture of the geophysical data product.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Various advantages of the present disclosure have been described herein, but embodiments may provide some, all, or none of such advantages, or may provide other advantages.

In the foregoing Detailed Description, some features are grouped together in a single embodiment for the purpose of streamlining the disclosure. This method of disclosure is not to be interpreted as reflecting an intention that the disclosed embodiments of the present disclosure have to use more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A method of performing a marine seismic survey, comprising:
actuating a plurality of non-impulsive sources such that each one of a plurality of common midpoint (CMP) bins receives a desired aggregate signal exposure,
wherein each one of the plurality of non-impulsive sources exposes each one of the plurality of CMP bins to a different part of the desired aggregate signal exposure at different times during the survey.

2. The method of claim 1, wherein the desired aggregate signal exposure comprises a frequency band, and the different parts comprise subsets of the frequency band.

3. The method of claim 2, further comprising spacing the plurality of non-impulsive sources apart in an in-line direction such that each one of the plurality of non-impulsive sources contributes different parts of the frequency band as it passes over each one of the plurality of CMP bins.

4. The method of claim 3, wherein each of the plurality of CMP bins has an in-line dimension, and wherein spacing the plurality of non-impulsive sources apart comprises spacing each one of the plural non-impulsive sources from its nearest neighbor by a distance that corresponds to the in-line dimension of one of the plurality of CMP bins.

5. The method of claim 1, wherein actuating the plurality of non-impulsive sources comprises actuating the plurality of non-impulsive sources when they are arranged in an in-line direction.

6. The method of claim 1, further comprising actuating the plurality of non-impulsive sources such that each one of the plurality of CMP bins is exposed to each one of a plurality of different frequency bands associated with each one of the plurality of non-impulsive sources.

7. A marine seismic survey system, comprising:
a plurality of receivers configured to record seismic data;
a plurality of non-impulsive sources; and
a controller configured to:
actuate the plurality of non-impulsive sources such that each one of a plurality of associated common midpoint (CMP) bins is exposed to a plurality of frequencies during a survey,
wherein each one of the plurality of non-impulsive sources exposes each one of the plurality of CMP bins to a different subset of the plurality of frequencies at different times during the survey.

8. The system of claim 7, wherein the plural non-impulsive sources are spaced apart in an inline direction.

9. The system of claim 8, wherein each of the plurality of CMP bins has an inline dimension, and wherein each one of the non-impulsive sources in the plurality of non-impulsive sources is spaced apart from its nearest neighbor by a distance corresponding to the inline dimension of one of the plurality of CMP bins.

10. The system of claim 7, wherein the controller is configured to actuate each of the plural sources according to a sweep signal.

11. The system of claim 10, wherein the sweep signal produces a linear sweep.

12. The system of claim 10, wherein the sweep signal produces a non-linear sweep.

13. The system of claim 7, wherein:
the plurality of non-impulsive sources is arranged in-line; and
each one of the plurality of CMP bins is exposed to different parts of the plurality of frequencies sequentially responsive to the actuation of the plurality of non-impulsive sources.

14. A non-transitory machine-readable medium storing instructions executable by a processing resource to:
actuate a plurality of non-impulsive sources spaced a particular distance apart as the plurality of non-impulsive sources moves through a body of water for a particular sweep length and duration, such that each of a plurality of CMP bins is exposed to a plurality of different frequencies associated with the plurality of non-impulsive sources at different times during a survey until each one of the plurality of CMP bins is exposed to a threshold number of frequencies,
wherein the particular distance is at most equal to an inline dimension of each one of the plurality of common midpoint (CMP) bins addressed by each one of the plurality of non-impulsive sources.

15. The medium of claim 14, further comprising instructions executable to actuate the plurality of non-impulsive sources in a plurality of simultaneous long linear sweeps.

16. The medium of claim 14, further comprising instructions executable to actuate the plurality of non-impulsive sources in a plurality of simultaneous short linear sweeps.

17. The medium of claim 14, further comprising instructions executable to actuate the plurality of non-impulsive sources in a plurality of simultaneous non-linear sweeps.

18. A method of manufacturing a geophysical data product, comprising:
actuating a plurality of non-impulsive sources in a body of water such that each one of a plurality of common midpoint (CMP) bins receives a desired aggregate signal exposure,
wherein each one of the plurality of non-impulsive sources exposes each one of the plurality of CMP bins to a different part of the desired aggregate signal exposure at different times during the survey; and
recording reflected seismic signals in a tangible computer-readable medium, thereby completing the manufacture of the geophysical data product.

19. The method of claim 18, wherein the desired aggregate signal exposure comprises a frequency band, and the different parts comprise subsets of the frequency band.

20. The method of claim 19, further comprising spacing the plurality of sources apart in an in-line direction by a distance corresponding to an inline dimension of the plurality of CMP bins, such that each one of the plurality of non-impulsive sources contributes different parts of the frequency band as it passes over each one of the plurality of CMP bins.
